(19) United States
(12) Patent Application Publication
(10) Pub. No.: US 2006/0167714 A1
(43) Pub. Date: Jul. 27, 2006

(54) Channel-aware enterprise service

(76) Inventors: Rodney Birch, Dublin (IE); Pete Maxwell, Dublin (IE); Jeff Schilling, Charlotte, NC (US)

Correspondence Address: SMITH FROHWEIN TEMPEL GREENLEE BLAHA, LLC, P.O. BOX 88148, ATLANTA, GA, 30356, US

(21) Appl. No.: 11/319,009

(22) Filed: Dec. 27, 2005

Related U.S. Application Data
(63) Continuation of application No. 11/026,071, filed on Dec. 30, 2004.

(51) Int. Cl. G06Q 99/00

(52) U.S. Cl. 705/1

(57) ABSTRACT

Various embodiments of systems, methods, computer programs, services, software components, etc. are provided. One embodiment comprises an enterprise platform for providing banking solutions to financial service providers. Logic embodied in a computer readable medium, the logic implemented on an enterprise platform in a financial service environment, the logic comprising: a module configured to execute a marketing campaign for a product across multiple channels of an enterprise platform; a module configured to send an offer for the marketed product over a channel of the enterprise platform; a module configured to associate the offer with a person; and a module configured to track the offer.

### RELATED APPLICATIONS

This application is a continuation of copending U.S. utility application entitled, “CHANNEL-AWARE ENTERPRISE SERVICE,” having Ser. No. 11/026,071, filed Dec. 30, 2004, which is entirely incorporated herein by reference.

### BACKGROUND

Service-oriented architectures based on software components and services have fundamentally changed the software industry. Service-based software platforms provide the functionality to build and interact with distributed applications by sending extensible markup language (XML) messages. Services represent a further architectural shift away from traditional monolithic applications (where the code that implements the business rules, data access, and user interface are all tightly coupled together as part of a single, large computer program). Services, such as web services or other software components, implement capabilities that are available to other applications (or even other web services, components, etc.) via industry standard network and application interfaces and protocols (e.g., XML, Simple Object Access Protocol (SOAP), Web Services Description Language (WSDL), Universal Description, Discovery, and Integration (UDDI), etc.).

A client application may use the capabilities of a service by invoking it across a network without having to integrate the code. In other words, services expose their capabilities to client applications, rather than their implementations. This allows services to be implemented in any language and on any platform and still be compatible with all client applications.

Services represent reusable software building blocks. Each building block, service, component, etc. is self-contained and describes its own capabilities, publishes its own programmatic interface, and implements its own functionality that is available as a hosted service. The business logic of the service runs on a remote machine that is accessible by other applications through the network. The client application invokes the functionality of a service by sending it messages, receiving return messages from the service, and then using the results within the application.

The modular, distributed, service-oriented architecture of services provides various benefits for software and IT professionals. For instance, this approach dramatically decreases application development costs by enabling developers to focus on their own value-added propositions. This approach also reduces many errors associated with complex and large monolithic applications. Furthermore, the services-oriented architecture simplifies applications maintenance and customization by segmenting an application into the client application and each of its consumed services or components.

As will be appreciated with reference to the description below, however, existing services, components, etc. have various limitations in the multi-channel enterprise environment. Therefore, there is a need in the art for systems, methods, computer programs, services, software components, etc. for providing channel-aware enterprise services.

### SUMMARY

Various embodiments of systems, methods, computer programs, services, software components, etc. are provided. One embodiment comprises logic embodied in a computer readable medium, the logic implemented on an enterprise platform in a financial service environment, the logic comprising: a module configured to execute a marketing campaign for a product across multiple channels of an enterprise platform; a module configured to send an offer for the marketed product over a channel of the enterprise platform; a module configured to associate the offer with a person; and a module configured to track the offer.

Another embodiment comprises, in a financial services environment, a method of offering services, the method comprising: executing a marketing campaign for a product across multiple channels of an enterprise platform; sending an offer for the marketed product over a channel of the enterprise platform; associating the offer with a person; and tracking the offer.

### BRIEF DESCRIPTION OF THE DRAWINGS

Other aspects, advantages and novel features of the invention will become more apparent from the following detailed description of exemplary embodiments of the invention when considered in conjunction with the following drawings.

FIG. 1 is a block diagram of one embodiment of an enterprise platform for providing a channel-aware enterprise service.

FIG. 2 is a flow chart illustrating the general operation of the enterprise platform of FIG. 1.

FIG. 3 is block diagram of another embodiment of an enterprise platform for providing a channel-aware enterprise service.

FIG. 4 is a block diagram illustrating an embodiment of a channel-aware authentication service.

FIG. 5 illustrates an embodiment of a data schema for implementing a channel-aware authorization service.

FIG. 6 illustrates another embodiment of a data schema for implementing a channel-aware historical interaction service (for employees and/or customers).

FIG. 7 illustrates another embodiment of a data schema for implementing a channel-aware service for executing an enterprise marketing campaign across multiple enterprise channels.

FIG. 8 illustrates another embodiment of a data schema for implementing a channel-aware service for managing incidents.

### DETAILED DESCRIPTION

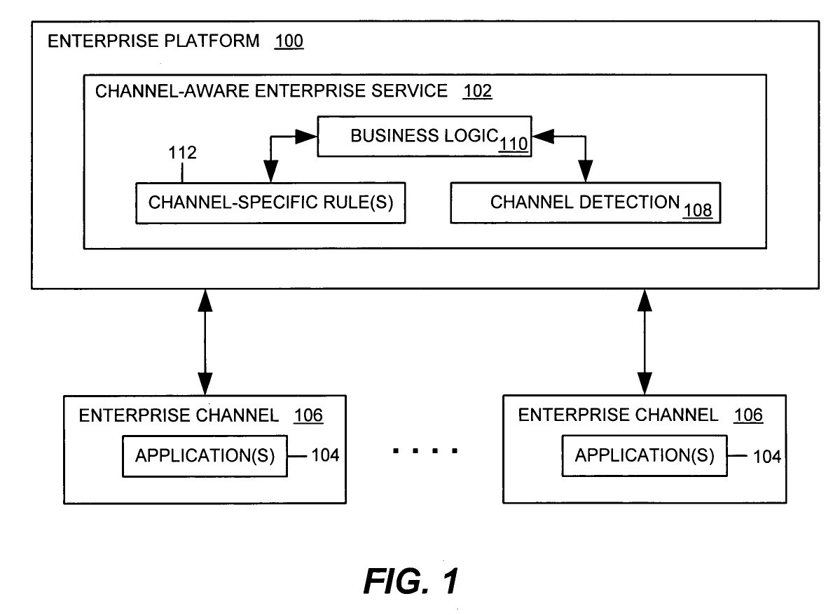

Various embodiments of systems, methods, computer programs, services, software components, etc. for providing channel-aware enterprise services are provided. Various embodiments are described below with respect to FIGS. 1-8. As an introductory matter, however, an exemplary embodiment of a channel-aware enterprise service (CAES) will be briefly described. In general, the exemplary CAES is implemented in a services-oriented architecture by an enterprise platform that provides business services to applications across multiple channels in the enterprise. In one embodiment, the enterprise platform functions as a front-end provider of banking solutions to financial services providers. It should be appreciated, however, that the enterprise platform may be configured to support any type of enterprise depending on the particular functionality of the business services, applications, etc.

The enterprise platform may support various types of channels of communication, conduits of interaction, etc. with the system. The channels may be characterized by applications, technologies, presentation logic requirements, business endpoints, consumer interactions, employee interactions, etc. In the example of a financial services provider, the enterprise may support full-service channels (e.g., bank branch, call center, etc.) for human-to-human interactions, self-service channels (e.g., Internet, interactive voice response (IVR) system, automated teller machine (ATM), etc.) for human-to-machine interactions, and automated channels (e.g., open financial exchange (OFX) transactions, web services, etc.) for machine-to-machine interactions.

To meet the demands of the enterprise, various applications may be employed across the various channels and which are supported by the enterprise platform. In accordance with the service-oriented architecture, the applications may be configured using a set of underlying building blocks, services, etc. These individual services are components that are put together in a flexible manner to deliver the desired business logic. The building blocks (e.g., web services) are provided by the enterprise platform and accessed by the applications. As known in the art, software services implement capabilities that are available to other applications (or even other services or software components) via industry standard network and application interfaces and protocols. An application can use the capabilities of a service (e.g., functions, data, business processes, etc.) by simply invoking it across a network without having to integrate it. In other words, services expose their capabilities to client applications—not their implementations. Therefore, services represent reusable software building blocks. This allows services to be implemented in any language and on any platform and still be compatible with client applications.

Each building block (service) is self-contained, and describes its own capabilities, publishes its own programmatic interface, and implements its own functionality that is available as a hosted service via the enterprise platform. The business logic of the service runs on a remote machine that is accessible by the enterprise applications through multiple channels. The enterprise applications invoke the functionality of the service by sending messages/requests to the service provided by enterprise platform, receiving return messages from the service, and using the results within the application. Because there is no need to integrate the services within the enterprise applications into a single, monolithic block, development and testing times, maintenance costs, etc. may be reduced. A more detailed description of services in the form of web-based services is included in Developing Enterprise Web Services: An Architect's Guide, Chatterjee, S. and Webber, J., Prentice Hall PTR, 2004, which is hereby incorporated by reference in its entirety.

Having described the general enterprise platform environment, the architecture, operation, and/or functionality of the exemplary CAES will be briefly described. The CAES comprises a service, software component(s), etc. for providing a fundamental business process to enterprise applications across multiple channels in an enterprise. As mentioned above, the fundamental business process may be configured as one of the underlying building blocks provided by the enterprise platform. In addition to the fundamental business logic, the CAES comprises a flexible mechanism for modifying the business logic based on the type of channel through which the service request is made. For example, one of the enterprise applications may make a request to the enterprise platform for the CAES. The CAES is configured to determine the channel sending the request and, if channel-specific business logic is required, to modify the business logic based on the channel. In this manner, the CAES may implement various channel-specific business processes using the underlying building blocks, components, etc. of the service-oriented architecture. This adaptive mechanism also eliminates the need to code channel-specific behavior within the enterprise applications.

FIG. 1 illustrates an embodiment of an enterprise platform 100 for providing a CAES 102 to applications 104 across multiple enterprise channels 106. As mentioned above, enterprise platform 100 is configured according to a service-oriented architecture and applications 104 are configured using a set of underlying building blocks, components, etc. called services. These individual services are components that are put together in a flexible manner to deliver the desired business logic. As an added form of flexibility, the business logic can be exposed as a set of easily adaptable business processes, which, when paired with the appropriate user interfaces, make up an application 104, which is then typically accessed through one or more enterprise channels 106.

The overall SOA promotes reuse within applications 104 as well as without. Because these services are accessible via industry-standard services interfaces, these building blocks can be reused by the enterprise applications 104 to form a more seamless solution for the customer. CAES 102 (and other services provided by enterprise platform 100) are configured to conform to two philosophies: channel neutrality and channel awareness.

With regard to channel neutrality, the services (and other components) are built to work across any enterprise channel 106. Channel neutrality makes it easier to reuse components, manage them, configure them, and extend them centrally. This reuse and centralization is, of course, a fundamental driver for lowering the total cost of ownership (TCO) of the overall system to enterprises (e.g., financial service providers, etc.).

Channel awareness extends the concepts of channel neutrality. Individual services as well as overall business processes can modify their own behavior based on the enterprise channel 106 that made the request. This eliminates the need to code channel-specific behavior within enterprise applications 104, yet allow fundamental building blocks to automatically adjust based on the most basic of contexts: the access channel.

As illustrated in the embodiment of FIG. 1, CAES 102 comprises a channel detection mechanism 108, business logic 110, and channel-specific rule(s) 112. Business logic 110 comprises the logic, functionality, capabilities, etc. associated with the fundamental building block of the service. It should be appreciated that business logic 110 may comprise any of the following or other capabilities: functions, routines, data, business processes, etc. Channel detection mechanism 108 comprises the means for determining the enterprise channel 106 through which the service request is made. One of ordinary skill in the art will appreciate that channel detection mechanism 108 may be implemented in various ways. In one embodiment, applications 104 are configured to generate channel identification parameter(s) that are provided with the service request or other messages with CAES 102. Channel detection mechanism 108 may include appropriate logic to interpret the channel identification parameters. For example, in one embodiment, a channel-specific communication infrastructure (e.g., web server, ATM switching software, PBX, etc.) may propagate a channel identifier to CAES 102. This may manifest itself as a filter on the channel-specific communication infrastructure such that the channel software itself is unaware of the mechanism.

Channel-specific rule(s) 112 determine the channel-specific business logic for one or more enterprise channels 106. In other words, channel-specific rule(s) 112 define deviations from the underlying business logic 110 for a particular enterprise channel 106. It should be appreciated that channel-specific rule(s) 112 may be implemented in various ways. In one embodiment, channel-specific rule(s) 112 are stored as the logic for modifying business logic 110 for a particular enterprise channel 106. In alternative embodiments, channel-specific rule(s) 112 may be stored as rules, tables, or any other information that may be used to modify the underlying business logic 110.

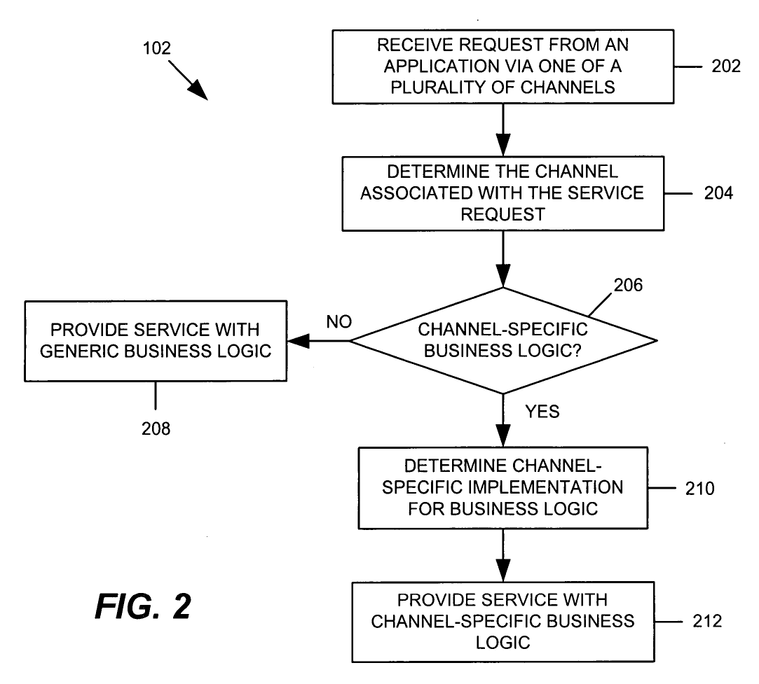

FIG. 2 illustrates the general architecture, operation, and/or functionality of an embodiment of CAES 102. At block 202, CAES 102 receives a request from an enterprise application 106 via one of the enterprise channels 106. At block 204, CAES 102 determines the channel associated with the request (e.g., channel detection 108—FIG. 1). At decision block 206, CAES 102 determines whether channel-specific business logic applies to the request, enterprise application 104, enterprise channel 106, etc. For example, in one embodiment, CAES 102 may automatically default to a “NO” state unless channel-specific treatment is triggered (e.g., via service request, channel-specific rule(s) 112, etc.). If there is no channel-specific business logic, at block 208, CAES 102 may proceed with providing the service using the underlying business logic 110. If, however, channel-specific logic does apply, at block 212, CAES 102 modifies business logic 110 based on the appropriate channel-specific rule(s) 112 for enterprise channel 106, and provides the service using the channel-specific business logic.

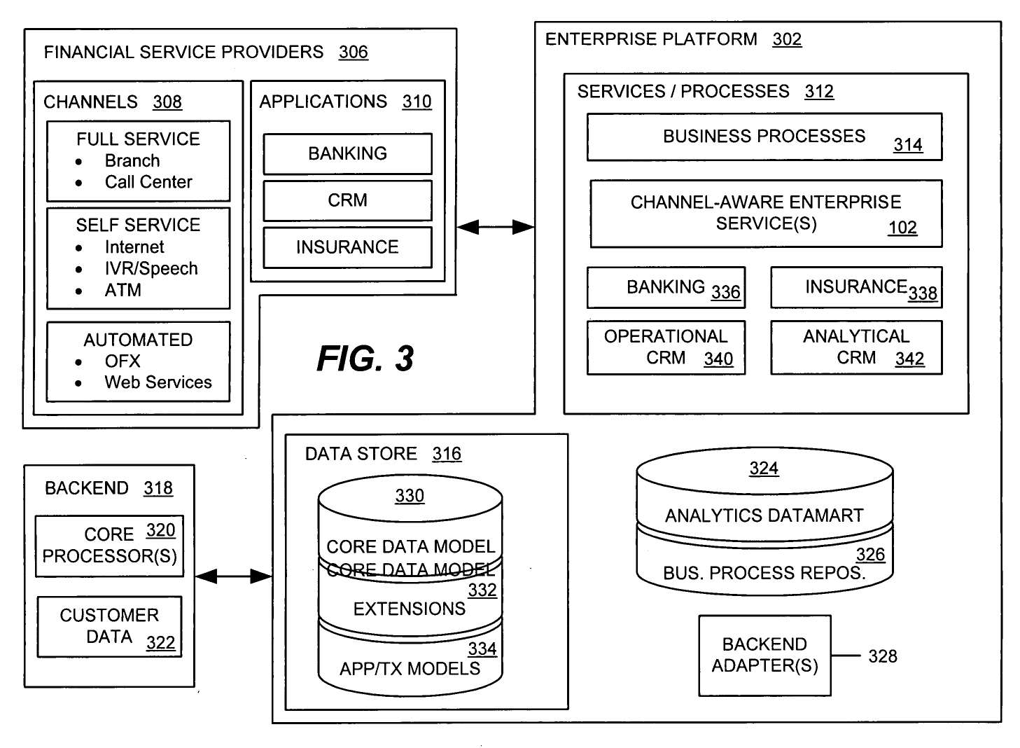

FIG. 3 illustrates another embodiment of an enterprise platform 302. Enterprise platform 302 functions as a front-end provider of banking solutions to financial service providers 306. Enterprise platform 302 employs a service-oriented architecture to provide services/processes 314 (including CAES 102) to applications 310 across channels 308. Applications 310 may include any suitable banking application. Applications 310 comprise groupings of specific features, functions, business processes, etc. In the embodiment illustrated in FIG. 3, applications 310 include a banking-related application(s), customer relationship management application(s), insurance applications, etc. Enterprise platform 302 includes corresponding services/processes for supporting each type of application (e.g., banking services 336, insurance services 338, operational CRM 340, and analytical CRM 342).

As further illustrated in FIG. 3, financial service providers 306 may use various channels 308 to support applications 310. Channels 308 provide the conduits of interaction with enterprise platform 302. For example, different channels 308 may require specific presentation logic in order to implement applications 310. Financial service providers 306 may include full-service channels (e.g., branch, call center, etc.) for human-to-human interactions, self-service channels (e.g., Internet, IVR/speech, ATM, etc.) for human-to-machine interaction, and automated channels (e.g., OFX, IFX, web services, etc.) for machine-to-machine interaction.

Enterprise platform 302 includes a data store 316 for storing core data model 330, extensions 332, and application/transaction data model(s) 334. Enterprise platform 302 also includes analytics datamart 324 and business process repository 326. Data store 316 may comprise a collection of business processes and services that fulfil the business and technical requirements of the system. Analytics datamart 324 may comprise a collection of historical information used to analyze behaviors, events, trends, etc. Business process repository 326 may comprise a collection of executable business processes that reflect the business practices of a customer of a financial service provider 306. For instance, these business practices may include decision matrices, actions, utility processes, etc.

Core data model 330 may comprise a database management system (DBMS) model that captures people, organizations, their relationships, products, marketing campaigns, customer interactions, authorization information, etc. Core data model 330 may provides a customer-centric model with a complete and consistent view of customers across all channels. Core data model 330 also enables customers to have a consistent view of financial service provider 306 across all channels. Core data model 330 may be application neutral, flexible, open, and extensible.

Extensions 332 and application/transaction data model(s) 334 contain application-specific data that may include transactional information for financial transactions (e.g., transfers, stop payments, check inquiries, etc.).

As further illustrated in FIG. 3, enterprise platform 302 may include various adapters (e.g., backend adapters 328) for providing front-office access to a backend 318 containing core processors 320 and customer data 322.

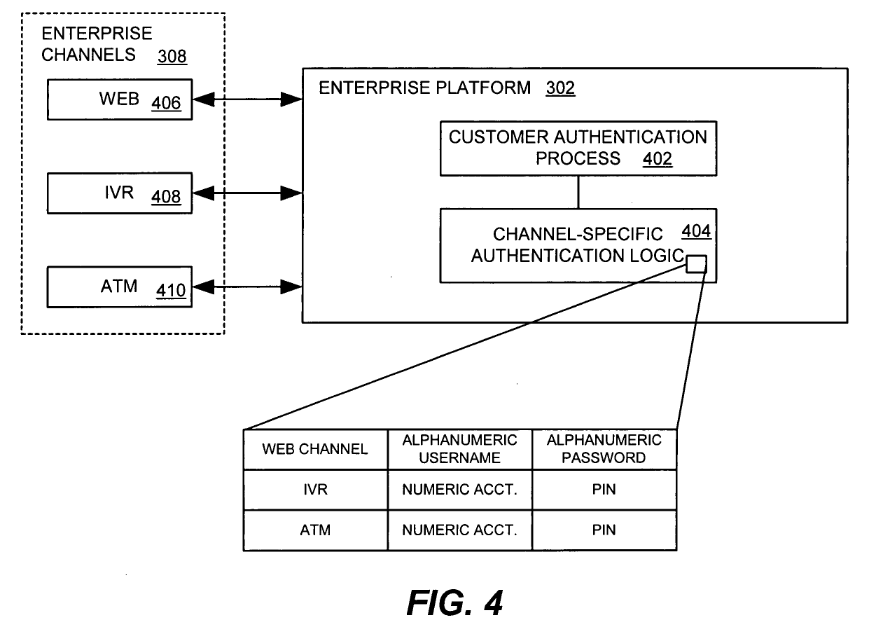

As mentioned above, CAES 102 may be configured to provide any desirable channel-aware service. FIG. 4 illustrates an embodiment of a CAES for providing a customer authentication process 402 based on channel-specific authentication logic 404. The authentication service supports applications 310 and may be configured to allow the system to ensure that the user is who the user claims to be. Only one authentication mechanism may exist for all application 310. The authentication service enables a user may be created, managed, deleted, and authenticated, regardless of what channel the user is accessing the system through. The authentication service is channel aware. While the user is managed centrally regardless of channel, the service can associate multiple sets of credentials that can differ based on the channel. As such, the user might be assigned an alphanumeric user name and associated password to access the system through a web channel 406 and/or an ATM channel 410, yet be assigned a numeric identifier and a numeric PIN to access the system through an IVR channel 408.

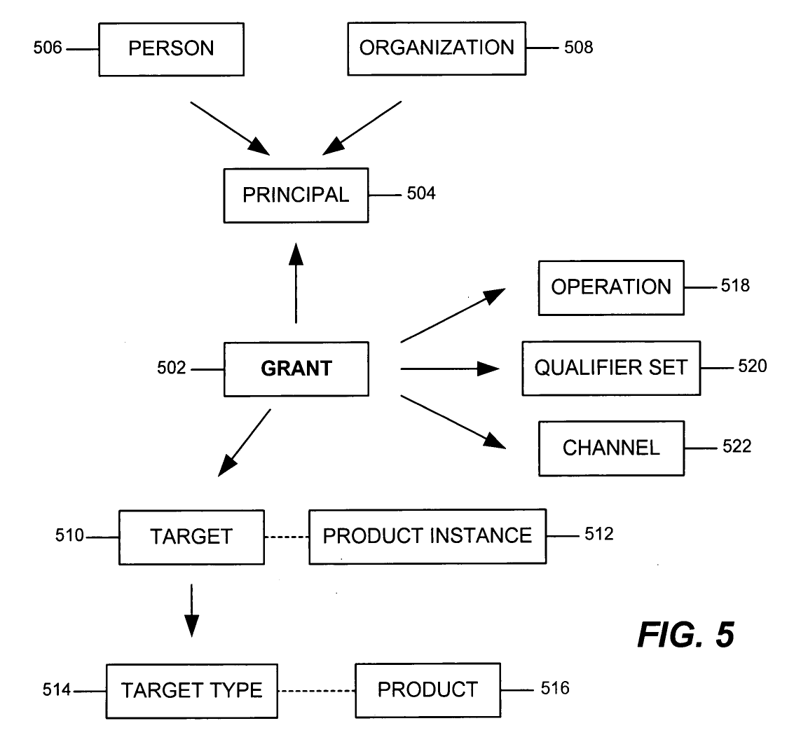

CAES 102 may also be configured to provide an authorization/entitlements service. FIG. 5 illustrates an embodiment of a data schema for implementing an authorization/entitlements service. The authorization/entitlements service is centralized and adheres to the channel aware concepts. It is the component that dictates who can perform what operations, on what targets, under what circumstances. The authorization/entitlements service may also govern operations such as who can modify a customer's profile, how much money a particular customer is allowed to transfer out of a particular account every day, etc. As mentioned above, this service is channel-aware in that the rules can vary based on the channel that the request is coming through. For example, a customer could be allowed to transfer $500 out of a particular account if the request is made through the Internet channel, but up to $1000 if the request is made in person at the branch. All of this channel awareness is stated as simple rules that are centralized and managed through, for example, an entitlements infrastructure, and do not have to be repeated within each application or channel.

Referring to the embodiment illustrated in FIG. 5, the authorization/entitlements service may grant (grant object 502) to a principal (principal object 504) the entitlement, right, authorization, etc. to perform an operation (operation object 518) on a specific channel (channel object 522) against a target (target object 510), subject to various qualifiers (qualifier set object 520). Principals and groups (e.g., person object 506, organization object 508) may be stored in the same table. It should be appreciated that grants/entitlements may be to various roles of principals and may be in the form of a tree structure. As illustrated in FIG. 5, target object 510 may be associated with a product instance object 512, target type object 514, product object 516.

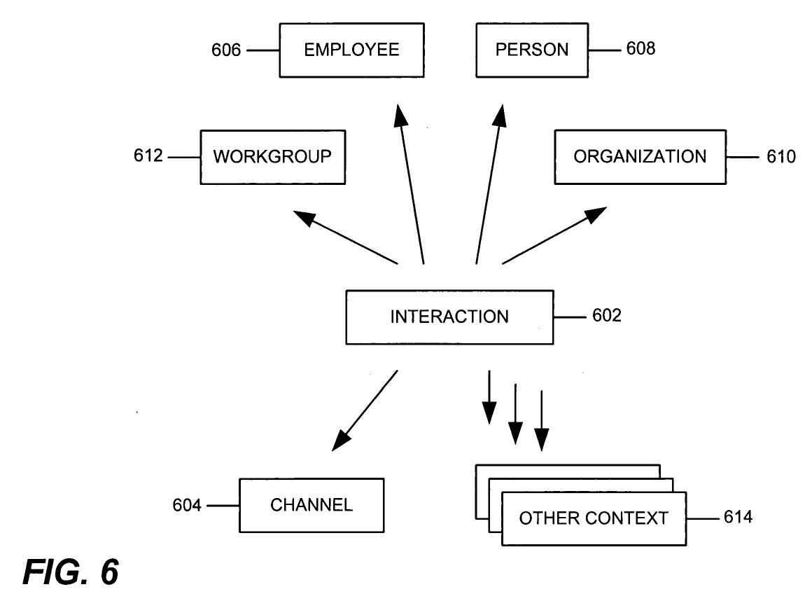

FIG. 6 illustrates an embodiment of a data schema for a channel-aware historical interaction service. This historical interaction service may track any interaction (interaction object 602) that a customer, prospect, etc. has had across any channel (channel object 604) supported by a financial service provider 306. As illustrated in FIG. 6, an interaction may be between multiple parties (e.g., between employee object 606, person object 608, organization object 610, workgroup object 612, etc.). The data schema may further include context information (context objects 614). The context information may include, for example, product instance, incident, channel, campaign offer, customer information, etc. As part of the historical interaction service, an employee of financial service provider 306 may reroute or delegate planned interaction(s) to another employee or workgroup. Incomplete items may be reclaimed, The historical interaction service may be useful in any of the following, or other, applications: for load balancing calls in the call center, managing holidays/employee absences, teamwork from a group queue/pool.

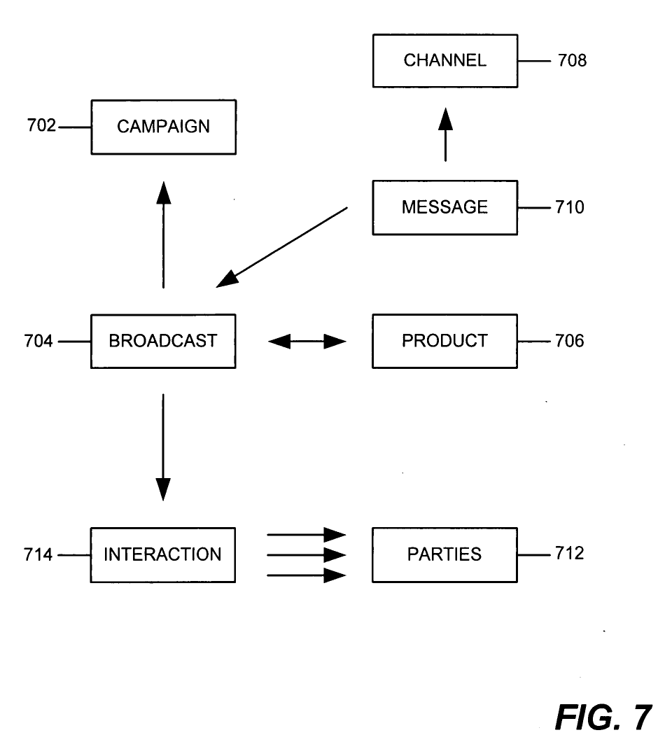

Another example of a CAES 102 is illustrated in FIG. 7 for executing a channel-aware marketing campaign across multiple channels. It should be appreciated that financial service providers 306 may desire to cross-sell products and services to customers. In order to accomplish this, a CAES may be implemented that presents one or more offers to the customer at a first customer contact, regardless of channel. These offers are typically tied to marketing campaigns initiated and managed by, for example, a marketing or analytics application supported by enterprise platform 302. As soon as the customer has accepted or declined the offer, it will not be presented again through any other channel. The ability to make the offer through any channel, at first customer contact, and the ability to coordinate across channels so as not to make redundant offers once the offer has been accepted or declined are two examples of the principle of channel neutrality. This campaign execution service may also be channel aware on two levels. At the first level, the service allows the offer to take a different form based on the channel through which it is being presented. If the customer contact is over an Internet channel, that offer may be made through a web banner advertisement. If the customer contacts the bank via the call center, the offer may be made through a carefully guided call script delivered by a customer service representative. If the customer walks up to the teller line, the offer will take the form of a teller referral delivered by the cashier after all the customer's transactions have been taken care of. At the second level, this service can be configured to deliver the offer to the customer through specific channels only. For example, an offer can be configured to be delivered through the Internet channel 4 times, through the call center channel 6 times, indefinitely at the teller line, and never through the IVR channel. It could also be configured to take into account the customer's preferences, such as his preferred method of contact. All of this logic is built into the service itself. The application using the service simply calls the service without regard to any of the above constraints. The service, knowing through which channel the call is made, returns the appropriate information after configuring its behavior based on the relevant channel-appropriate rules.

Referring to the embodiment of FIG. 7, the channel-aware service may implement a marketing campaign (campaign object 702). The marketing campaign may execute several different broadcasts (broadcast object 704) which may promote different products (product object 706) at different times, via different channels (channel object 708). The messages associated with the marketing campaign (message object 710) can be made available cor collection via several touch-point channels. It should be appreciated that the messages may be channel-specific. The broadcasts may be target segments or cells of the campaign population (parties object 712). Each broadcast may define various planned interactions (interaction object 714) with the target customers, which may be tracked as described above.

CAES 102 may also be configured to support a new account opening service. This is an example of channel neutrality and channel awareness manifested at the process level rather than the service level. Processes are defined as a series of steps that may call one or more services each. A new account opening process might include calling a customer profile service, an account service, a transfer service, and a fulfillment sub-process. A bank that decides to offer its customers the ability to open an account over the Internet channel will invariably deploy a different process for that channel compared to the call center or the branch. The types of products offered will be different, as banks will reserve the more complex products for the branch and limit the type of products they offer through the Internet. The number of steps, the flow of the screen, and the number of options offered might also be very different based on the channel. The process is very much channel-aware. However, some aspects of the channel might be channel neutral. The fulfillment sub-process, for example, which might include ordering the debit card, the check book, and the welcome letter, could be the same used across all channels.

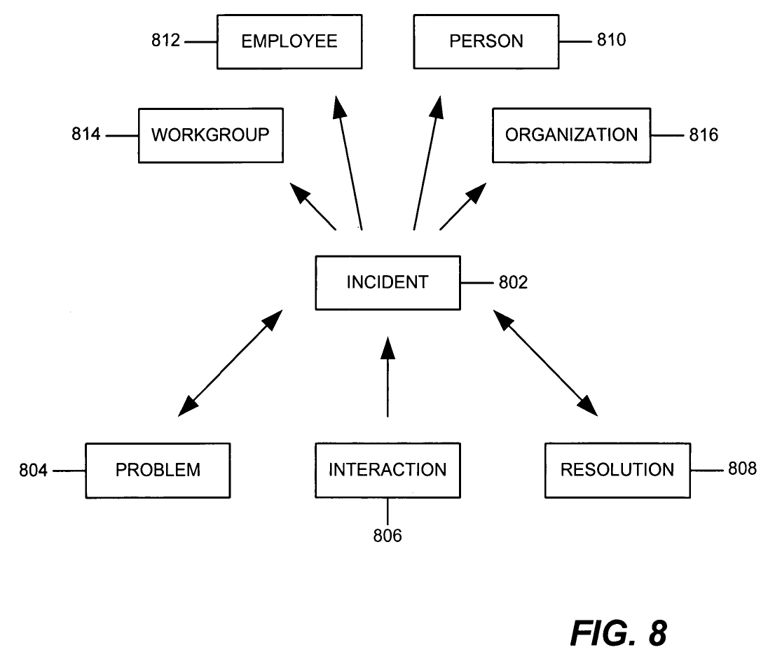

Another channel-aware enterprise service for managing enterprise incidents is illustrated in FIG. 8. This service comprises an incident object 802 representing a problem (object 804), interaction (object 806), and resolution (object 808). As illustrated in FIG. 8, each incident may be associated with various parties (e.g., person object 810, employee object 812, workgroup object 814, organization object 816). It should be appreciated that channel-awareness may be implemented via interaction object 806, in much the same manner as interaction object 602 (FIG. 6) described above. For instance, the customer interactions with the system are tracked by channel using this architecture. It should be further appreciated that a customer interaction sub-system may be configured to implement various channel-aware behavior. In one embodiment, any of the following, or other, channel-aware behavior may be implemented: tracking of which channel the incident was reported through and by whom; tracking of which channel the incident occurred through (if applicable); tracking of which employee (in the case of a full-service channel) was involved in the incident (if applicable); tracking of which employee resolved the incident (if resolution was done through a full-service channel) and through which channel; tracking of how many interactions it took to move an incident from a problem to a resolution; tracking the distribution of incidence occurrence per channel; tracking the rate of closure of incidents per channel, etc. These types of information may be used to analyze which channels are the most efficient, which are more/less profitable, which require attention to improve customer service, training, etc.

One of ordinary skill in the art will appreciate that the channel-aware enterprise services may be implemented using various technologies, including but not limited to, XML, SOAP, WSDL, UDDI, etc. It should be further appreciated, however, that alternative embodiments may include other technologies. Furthermore, the channel-aware enterprise services may be implemented as services (e.g., web services) or any other software component(s) in a service-oriented architecture.

Although this disclosure describes various embodiments, the invention is not limited to those embodiments. Rather, a person skilled in the art will construe the appended claims broadly, to include other variants and embodiments of the invention, which those skilled in the art may make or use without departing from the scope and range of equivalents of the invention.

What is claimed is:

1. In a financial services environment, a method of offering services, the method comprising:
executing a marketing campaign for a product across multiple channels of an enterprise platform;
sending an offer for the marketed product over a channel of the enterprise platform;
associating the offer with a person; and
tracking the offer.

2. The method of claim 1, wherein the step of tracking the offer further includes the steps of:
determining whether the person accepted the offer;
responsive to the determining that the person accepted the offer, configuring the enterprise platform to not send a second offer for the marketed product.

3. The method of claim 1, wherein the step of tracking the offer further includes the steps of:
determining whether the person declined the offer;
responsive to the determining that the person declined the offer, configuring the enterprise platform to not send a second offer for the marketed product.

4. The method of claim 1, further including the steps of:
configuring the enterprise platform such that the offer for the marketed product can be presented to the person through multiple channels of the enterprise platform;
coordinating the presentation of the offer across the multiple channels of the enterprise platform.

5. The method of claim 4, wherein the step of tracking further includes the step of:
executing a historical interaction service that tracks interactions that the person has had across the multiple channels of the enterprise platform.

6. The method of claim 5, further including the steps of:
delegating a planned interaction with the person, wherein a first employee delegates the planned interaction with the person to a second employee.

7. The method of claim 5, further including the steps of:
delegating a planned interaction with the person, wherein a first employee of a first work group delegates the planned interaction with the person to a second work group.

8. Logic embodied in a computer readable medium, the logic implemented on an enterprise platform in a financial service environment, the logic comprising:
a module configured to execute a marketing campaign for a product across multiple channels of an enterprise platform;
a module configured to send an offer for the marketed product over a channel of the enterprise platform;
a module configured to associate the offer with a person; and
a module configured to track the offer.

9. The logic of claim 8, wherein the module configure to track the offer further includes:
a module configured to determine whether the person accepted the offer, wherein responsive to the module configured to determine that the person accepted the offer, a second offer for the marketed product is not sent to the person.

10. The logic of claim 8, wherein the module configure to track the offer further includes:
a module configured to determining whether the person declined the offer wherein responsive to the module configured to determine that the person declined the offer, a second offer for the marketed product is not sent to the person.

11. The logic of claim 8, further including
a module configured to configue the enterprise platform such that the offer for the marketed product can be presented to the person through multiple channels of the enterprise platform;
a module configured to coordinate the presentation of the offer across the multiple channels of the enterprise platform.

12. The logic of claim 11, wherein the module configured to track the offer further includes:
a module configured to execute a historical interaction service that tracks interactions that the person has had across the multiple channels of the enterprise platform.

13. The logic of claim 12, further including:
a module configured to delegate a planned interaction with the person, wherein a first employee delegates the planned interaction with the person to a second employee.

14. The logic of claim 12, further including:
a module configured to delegate a planned interaction with the person, wherein a first employee of a first work group delegates the planned interaction with the person to a second work group.
